(19) United States
(12) Patent Application Publication
(10) Pub. No.: US 2003/0093613 A1
(43) Pub. Date: May 15, 2003

(54) Compressed ternary mask system and method

(76) Inventor: David Sherman, Fremont, CA (US)

Correspondence Address: GARY CARY WARE & FREIDENRICH LLP, 1755 EMBARCADERO ROAD, PALO ALTO, CA, 94303-3340, US

(21) Appl. No.: 10/215,534

(22) Filed: Aug. 9, 2002

Related U.S. Application Data
(63) Continuation-in-part of application No. 10/087,725, filed on Mar. 1, 2002.
(63) Continuation of application No. 09/483,206, filed on Jan. 14, 2000, now Pat. No. 6,389,507.
(60) Provisional application No. 60/311,112, filed on Aug. 9, 2001.

(51) Int. Cl. G06F 17/30; G06F 7/00

(52) U.S. Cl. 711/104; 707/3

(57) ABSTRACT

A compressed ternary mask system and method is described. The system and method compresses masks in a search tree such that a single comparison may be completed for each branch level of the tree. In a preferred embodiment, a tree having a root level, a 2nd level and a leaf level may be used to implement the method.

### RELATED APPLICATIONS

This application claims priority under 35 U.S.C. §119 from U.S. Provisional Application Serial No. 60/311,112 filed on Aug. 9, 2001 and entitled “Compressed Ternary Mask”. In addition, this application claim priority under 35 U.S.C. §120 and is a continuation in part of U.S. patent application Ser. No. 10/087,725 filed Mar. 1, 2002, which is a continuation of U.S. patent application Ser. No. 09/483,206 filed on Jan. 14, 2000 (now issued U.S. Pat. No. 6,389,507).

This application also claim priority from Disclosure Document No. SV01051 which should be retained.

### BACKGROUND OF THE INVENTION

This invention relates generally to a content addressable memory and in particular to a system and method for the operation of the content addressable memory.

The problem of searching a database for particular arbitrary sets of bitstrings in entries is a very difficult problem and difficult to cast in hardware solutions, since there are so many types of searches & data patterns possible. However, there is a subset of this general problem that historically has also been perceived as very intractable for hardware solutions but is now solved by the system and method described herein.

One very useful type of database is composed of “ternary entries” that have 2 components to each entry, a binary datum and a “don't care mask” for that datum. Internet traffic is commonly routed by “forwarding tables” based on databases composed of entries such as this, where the masks are applied to contiguous low order bits of the binary datum. Searches are performed on these data bases using a binary “key”, and the returned match is the entry that matches the key for the unmasked portions, such that the mask in the winning match is the smallest of all the entries that matched. (That is, the match that contains the highest “precision” of match by matching in the largest number of significant bits is the winner.) These ternary entries define a “group” of binary values that all have the same “membership”.

Another useful subset of database searches is performed on a database that is composed of entries that consist of fields that are “concatenated” versions of the ternary entries described above. That is, each field is examined for the “best match” within its field, and the winning entries (there can be many that match in the most general case) are further culled based on other criteria, such as “best match in the highest order field” or “best match in total number of bits” or “highest priority” based on some other figure of merit, such as QoS (“quality of service”) that any of the matching entries in the routing data base indicates a packet requires. In the case of this type of concatenated search the desire is usually to apply the results of the searching process to provision a switching network to forward groups of packets called “flows”. (Flows usually refer to packets coming from a particular IP address and destined for a particular IP destination, or using particular “ports” in the switch. “Flows” are composed of many individual packets that must be treated in an identical manner in terms of routing priority.) Another way to think of concatenated entries is as a volume in N-space, where N is the number of distinct bit fields, that again defines “membership” for a collection of binary points.

An important metric for any search algorithm and hardware implementation is how many accesses to the database being searched have to be performed to achieve the best match. The ideal is one access per match, which of course is extremely difficult to achieve. The hardware described here achieves that for the single field ternary database described above. It uses a Tree Search with compressed mask information stored in the root & branches of the tree to provide enough information to guarantee that only one leaf memory access is required per match. After describing the single field version in detail, the algorithm is expanded to cover the more general concatenated cases as a means to greatly refine the search so that matches can be handed off for subsequent refinement to more flexible hardware or software.

While we have focused on networking routing, searches of fields in databases & performing “fuzzy” searches is a generally useful computational task that can benefit from acceleration, so this algorithm described below and it's mapping to hardware solutions has wide utility. Thus, it is desirable to provide a compressed mask ternary mask system and method and it is to this end that the present invention is directed.

### SUMMARY OF THE INVENTION

The compressed ternary mask in accordance with the invention generates a compressed mask for each branch in a search tree wherein the search tree have one or more levels which contain the data to be searched. In accordance with the invention. a compressed mask (a merge operation) is generated wherein the compressed mask represents the masks for all of the masks of the leafs associated with a particular branch in the tree so that a single memory access can be used to perform a ternary comparison. In a preferred embodiment, the masks for the leafs of the tree may be generated by using an edge extraction process for all the masks and then logical ORing the edge extracted values together to generate the compressed ternary mask.

In more detail, to implement the compressed ternary mask compression and perform a tree search on ternary entries, it is desirable to have information about the entries' masking residing in the tree branch nodes to assist the search. A convenient representation for mask values in the tree is the single “1” bit of the “edge extracted” mask, because masks from multiple entries can be represented in a single mask word in the tree. That is, as a search is conducted, all unique mask values present in the next level of the tree can be represented in one memory access to a mask value. In our case described here, all 32 possible mask lengths associated with a branch value can be determined under the assumption that we have “OR'd” all the edge extracted values together into one tree memory location. If there are no duplicate entries in the leaf memory, then there is one unique branch entry or leaf entry associated with each mask size (i.e., each edge extracted bit weight).

Once the compressed ternary mask for each branch is generated, it permits a binary search and the ternary equality comparison to be performed with a single memory access so that the searching process is made more efficient. During the searching process, a key to be searched for is provided to the system. The key is then compared to each branch of the tree to determine the branch in which the value may be located. The branch is chosen wherein the key value is greater than the branch value (the smallest data value contained in the branch) and less than the next branch value. Once the branch is selected, the key is compared to the values located in the leaf elements selected by the branch. If the match occurs to a value, the address of that value is returned to the user since it is the best match with the minimal masked bits. If the values in the selected branch do not match the key, then the key is compared to the other branches using the compressed masks.

### BRIEF DESCRIPTION OF THE DRAWINGS

FIG. 1 is a diagram illustrating an example of a memory that may include the compressed ternary mask system in accordance with the invention;

FIG. 2 is a diagram illustrating more details of the search architecture;

FIG. 3 is a diagram illustrating more details of the search architecture;

FIG. 4 is an alternate view of the TREE branching data structure in accordance with the invention;

FIG. 5 is a flowchart illustrating a method for compressed ternary searching in accordance with the invention;

FIGS. 6A-6C are diagrams illustrating examples of a tree entry insertion method in accordance with the invention;

FIG. 7A is a diagram illustrating pseudocode for a preferred up smoothing method in accordance with the invention;

FIG. 7B is an example of a down smoothing method in accordance with the invention;

FIG. 8 is an example of preferred hardware logic that may be used to implement the compressed ternary mask in accordance with the invention;

FIGS. 9A and 9B illustrate a root level insertion method in accordance with the invention;

FIGS. 10A and 10B illustrate a branch level insertion method in accordance with the invention;

FIG. 11 illustrates a leaf level insertion method in accordance with the invention;

FIG. 12 illustrates a root level match method in accordance with the invention;

FIGS. 13A-13C illustrates a branch level match method in accordance with the invention;

FIG. 14 illustrates a leaf level match method in accordance with the invention;

FIG. 15 illustrates a delete method in accordance with the invention;

FIG. 16 illustrates the definition of a merge operation on a simplified number line; and

FIG. 17 illustrates pipelined execution of the compressed ternary mask method in accordance with the invention.

### DETAILED DESCRIPTION OF A PREFERRED EMBODIMENT

The invention is particularly applicable to a MAXCAM memory system and it is in this context that the invention will be described. It will be appreciated, however, that the system and method in accordance with the invention has greater utility since it may be used with various different memory architectures and computer systems. Furthermore, the methods are applicable to other fields of use in addition to computer memory systems. In this description, all data are represented as hexidecimal numbers unless otherwise indicated. Prior to describing the compressed mask system and method in accordance with the invention, an example of a memory device that may utilize the compressed ternary mask system will be described briefly.

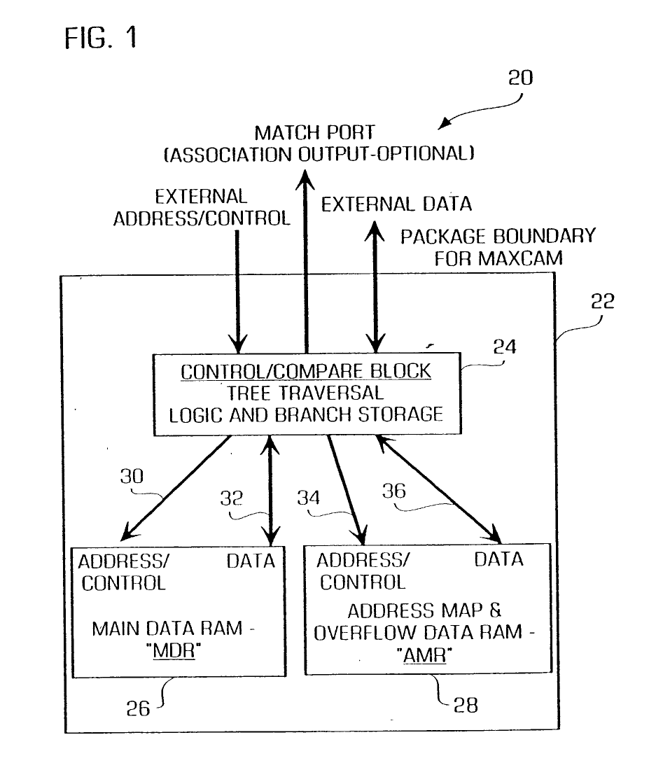

FIG. 1 is an example of a content addressable memory (CAM) 20 that may be used to implement the compressed ternary mask system and method in accordance with the invention. In particular, the CAM 20 may include a semiconductor die 22 that interfaces to other external integrated circuits (ICs). The external ICs may, for example, supply an external address and control signals and other external data to the die 22 and may receive data from the die 22 that may include optional match port data indicating a match has occurred between a location in the CAM and the data in the compare register.

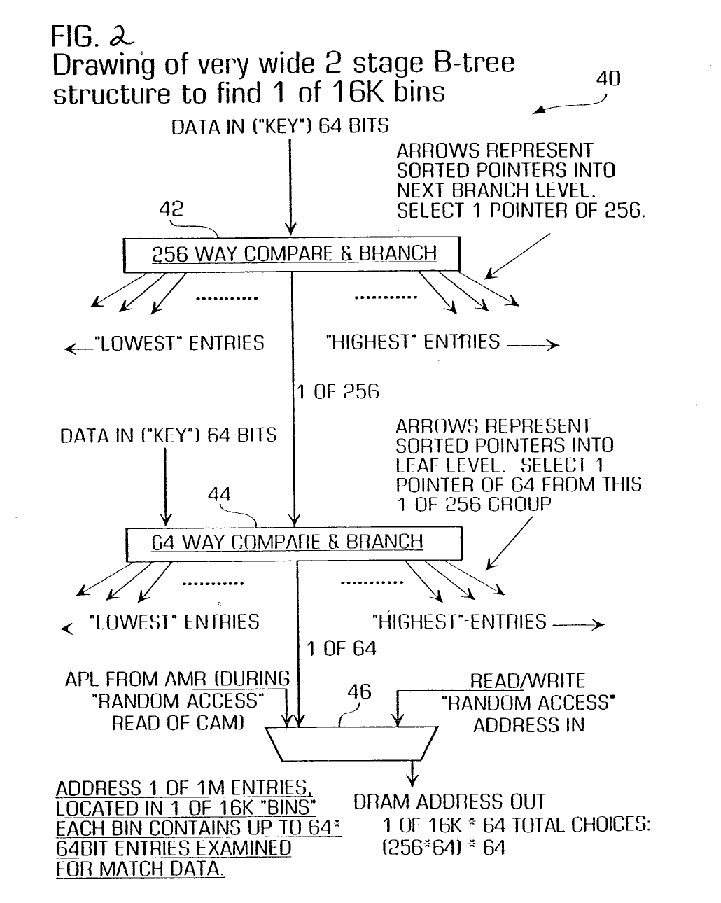

The semiconductor die 22 may include a control/compare block 24, a main data RAM (MDR) 26 and an address map and overflow data RAM (AMR) 28. The MDR and AMR are each separate typical RAM memory devices in this embodiment. The control/compare block 24, that is described below in more detail with reference to FIGS. 2-11, may control the operation of the CAM including storing data and performing the data comparison as described below. The control/compare block 24 may also include tree traversal logic in accordance with the invention that implements the searching method and system in accordance with the invention. The MDR 26 may contain the main memory store for the CAM, may be controlled by the control/compare block using an address/control bus 30, and may communicate data with the control/compare block and receive data over a data bus 32. Similarly, the AMR 28 may contain an address map of the contents of the CAM and overflow data RAM, may be controlled by the control/compare block using an address/control bus 34, and may communicate data with the control/compare block and receive data over a data bus 36.

In operation, the control/compare block 24 may organize the 2 RAM memories (MDR and AMR) and access them appropriately to achieve the desired CAM operation. As described above, these functions can be contained on a single silicon die or on several dies in a multi-chip package. In the preferred embodiment shown, the MDR 26 may hold 8 Mbytes of stored RAM/CAM data. The AMR 28 may contain both the intended address location (IML) of the data stored at a corresponding physical location in the MDR and the actual physical location (APL) of the stored data for RAM-style read queries.

The link structures for the data records of the AMR may look like:

AMR_Data[63 . . . 40, 39 . . . 20, 19 . . . 0]

wherein bits 40-63 contain various flags and short links, APL data is stored in locations 20-39 and IML data is stored in locations 0-19 as described in more detail in Table 1. The structure shown above is for a particular preferred embodiment with a particular implementation and the structure may be changed for different implementations without departing from the scope of the invention.

TABLE 1
Bit field meaning for AMR data for 1M*64 CAM

| Field Name | Bit position | Brief Description |
|---|---|---|
| IML: | [19:0] | This is the destination address indicated by the |
| “Intended Address | | external address during a RAM write command to |
| Location” | | CAM area. This is returned as part (or all) of the |
| | | association mapping during the CAM operation, |
| | | once a data pattern match is completed. This field |
| | | is stored in the AMR at the “same” (or simply |
| | | mapped) address as the Data in the MDR. |
| APL: “Actual | [39:20] | During a RAM read to the CAM area, this is |
| Physical Location” | | fetched first and used as the address for the MDR to |
| | | fetch data. This implies that RAM reads are |
| | | generally Random Accesses to MDR. This is |
| | | generally true for database management tasks, until |
| | | an actual table is being fetched. This field is stored |
| | | at the address pointed to by the IML, that is, the |
| | | location where the data would have been stored in a |
| | | regular RAM. |
| LINKS/flags: | 63:40 | This is dependent on implementation details. |

The 2 DRAM blocks (MDR and AMR) may also be available as very fast SRAM in which case the Controller/Comparer 24 may configure the CAM to allocate anywhere from 0-100% of the DRAM memory locations to the CAM and the remainder to the RAM operation. Even with the allocation of memory locations, the system still permits RAM-style accesses to the part being used (mapped) to the CAM operation. For the memory locations being used for strictly RAM operations typical full speed burst operations may be available. This allows the CAM to be used in DIMM sockets in servers that permits an easy upgrade path for use in list processing and data manipulation tasks in servers. Further description and disclosure of the exemplary memory device are described in co-pending U.S. patent application Ser. No. 10/087,725 filed Mar. 1, 2002 which is owned by the same assignee as the present application and is incorporated herein by reference. Now, the compressed ternary mask system and method in accordance with the invention will be described.

The compressed ternary mask system and method in accordance with the invention may be used to facilitate the searching for a entry in a content addressable memory as described above. For clarity, several terms will be explained, examples of the data types will be provided and the match process will be described. However, the invention is not limited to the examples provided herein and, for example, may be used with other data types and data sizes and other match processes. For purposes of illustration, a typical entry will be a 32 bit binary “datum” paired with a 32 bit “mask”. Since the masked bits in the data portion are by definition “don't care” in the database/memory, we can enforce a policy that masked data bits must be stored as all ‘0” in the leaf entries (i.e. the actual data base main storage). Mask values must be right justified and can not contain interior “0s”. (e.g. 00007EFF would be illegal since bit weight=256 decimal is 0). Data bit weights that are masked are indicted by a “1 ” set in the companion mask. Now, several example of a piece of data and its corresponding mask will be described.

The database may contain the following examples of data and masks:

| Entry Number | Data | Mask |
|---|---|---|
| 1 | 34567900 | 000000FF |
| 2 | 38700000 | 000FFFFF |
| 3 | 77467878 | 00000007 |
| 4 | 77467870 | 0000000F |
| 5 | 38700000 | 00000007 |

As is well known, a particular piece of data to be matched, known as a “key”, may be provided to the database. The key is then tested against the entries in the database to determine if a match has occurred. For example, if the key “7746787F” was presented to the database containing the above entries, it would match both entries #3 and #4, but entry #3 would be returned as the best match due to the smaller number of mask bits.

We define the term “split values”, “SV0” and “SV1”. Split values are the binary numbers created by substituting all “0” (i.e., the SV0) or all “1” (i.e., the SV1) in the data at bit weights that are masked for an entry. For example, in entry #2 above, the SV0=38700000 and the SV1=387FFFFF. Given our requirement that the stored data contain all “0” in masked bit locations, “SV0” is the stored leaf data component of an entry and “SV1” is the stored data component of the entry logically OR'd with the mask component. Thus, “SV0” is the lowest endpoint of the range of values defined by a database entry with the mask, and “SV1” is the highest endpoint. Any binary key presented to the database that falls between “SV0” and “SV1” will match that entry.

If the bits of the data and the mask are paired for each bit weight (bit position), they create the following values:

| Data Bit | Mask Bit | Comment |
|---|---|---|
| 0 | 0 | a legal value of “0” |
| 0 | 1 | a legal value of “masked” |
| 1 | 0 | ale al value of “1” |
| 1 | 1 | illegal bit value in a database (leaf) entry. This is |
| | | value is reserved for use in the root & branches of |
| | | the tree. |

Another representation for a data/mask pair, given the definitions above is to specify the mask by the most significant bit only, since all lower weight bits must be 1 by definition, they provide no additional information. This can be realized by an “edge extraction” circuit (XOR neighboring bits). So the table above could also be represented as:

| Entry Number | Data | Mask |
|---|---|---|
| 1 | 34567900 | 00000080 |
| 2 | 38700000 | 00080000 |
| 3 | 77467878 | 00000004 |
| 4 | 77467870 | 00000008 |
| 5 | 38700000 | 00000004 |

As described further below, an entity called a “MERGE” can be created in the root & branch of the tree. A MERGE does not occur in the leaf (database) entries. For now, an example of a MERGE will suffice: the value “77467878/0000000C” occurring in the branches of the tree is a “MERGE” of the leaf entries #3 & #4 above for example. In particular, a MERGE is created by “ORing” the edge extracted masks of leaf entries together in the branch entries. The reason for this will be described in detail below, but succinctly stated it allows a representation of multiple leaf entries at the branch & root levels in an unambiguous manner. As long as there are no identical database entries stored, use of the MERGE concept allows one leaf access resolution to the best ternary match.

As is well known, all memory technologies fetch more data from the core than is ultimately presented to the I/O's on a per clock basis. The assumption for this algorithm to resolve to best match in one access is that many database entries are fetched in parallel during one access to the memory core. This is certainly true in DRAM technology, where 2 k to 8 k bits are usually fetched in one random access. In our example width here of 32 bits, that corresponds to 32 to 128 individual entries (2*32 bits per entry to accommodate a data & mask pair). Using embedded memory technology it is conceptually straightforward to design pitch matched comparison logic to examine all the fetched entries in parallel in the next clock in a pipelined manner. An alternative is to design a very wide standard memory, for instance 128 bits wide, which can put out 16*128 bit data cycles externally to fetch all the data from the memory to the comparison logic (this would ideally be performed in a multi-die module to reduce power dissipation to drive that much data at the required speeds of many 100's of MHz I/O rates). In any case, the number of entries fetched per memory access must be equal to the number of entries in each leaf node (“bin” of leaf entries). If the compressed ternary mask system is mapped to hardware using narrower standard memories, then it may take many clock cycles to find the best match by virtue of the random access memory speeds. This is still a significant speed up and/or density advantage compared to alternative prior art, however in this description it is assumed that the appropriate memory technology is available and is used.

To better understand the invention, a brief discussion of B+ tree type associative memory architectures will be provided. A Tree search on binary databases (i.e., without associated mask values) are well known in the literature, so only as much detail as is required to adequately describe the compressed ternary mask system in accordance with the invention will be included here. In addition, further information may be found in U.S. patent application Ser. No. 10/087,725 which has already been incorporated by reference.

The underlying advantage of a tree search that branches many ways at each level in the tree is that it can resolve down to potential matches very quickly in a very large memory. For example, if the root of the tree branches 256 ways and each 2^{nd} level in the tree branches 64 ways and there are 64 entries in a leaf examined simultaneously, then a 3 deep tree (i.e., root, branch & leaf) can find a match in a pipelined manner every clock using a “3 deep” pipeline (assuming each level of the tree branches takes a clock to perform 2 memory accesses and the leaf memory can perform one access per clock, as developed below) and the total database can be 1 Million entries. One more level in the tree would result in a 64 Million entry database. Typically, doing multi-way branches in software is usually implemented in practical terms as a simple binary partitioning search in the inner loop, defeating much of the benefit. This once more implies that the system in accordance with the invention is best achieved using specialized memory and custom computational units tightly coupled with the memory.

The way in which the tree is traversed is very simple. The range of values that a particular branch represents is defined by one of the end points of a range, with the other end of the range being defined by the value stored in the next higher (lower) branch. For example, in the compressed ternary mask system in accordance with the invention, each branch stores the lower end of a range. Then, a key is compared to each branch value, and the largest branch that is lower than the key, is followed to the next level. This novel method is recursively applied to each branch level of the tree structure until a final “bin” of values in a leaf node is reached. Then, the values in the leaf node are compared for an exact binary match. If the key matches a value in the leaf node, the address of where the matched value is stored (or an address pointed to indirectly from the leaf address) is returned as the “associated value”.

In the novel method, one goal is to facilitate the tree to look like an “ordinary random access memory” so that it can also be queried for data matches as one does with a ordinary random access memory. To that end, in accordance with the invention, each entry includes the address where the application “stored it” which is called the IML, or “Intended Memory Location”. At the address in the physical memory specified by the IML is a pointer called the APL or “Actual Physical Location”. The APL is a pointer to where, in the leaves of the tree, the data structure for the entry is finally stored. Therefore, if the application wants to fetch an entry in a random access read, the APL is fetched as an indirect pointer to access the entry in order to return the read data. During the associative (CAM/tree) operation, when the best data/mask match is found, the IML is returned as the association. These extra pointers allow the tree structure to appear to be a type of Ternary CAM to the application. Further details of this operation is described in U.S. patent application Ser. No. 10/087,725 which has already been incorporated by reference.

The complication of having masked data in the database is that many matches could conceivably occur down multiple branches of tree. Therefore, selecting the “best” match of millions of entries that could all be masked in a manner that defines an arbitrary number of overlapping ranges of “split values” is a daunting task. For example, an entry that is highly masked could be the “best match” to a key that is trying to search down a branch that has a data portion of the entries that more closely matches the key, if there is in fact no further match. “Overlapping candidate values” have been resolved previously in the art by conducting multiple accesses to check the possible candidates in the tree. The strength of the current novel system and method is that it is a strictly BINARY search which can be conducted down the tree to the appropriate “best” leaf node, while a parallel TERNARY EQUALITY search is conducted in the tree to provide matches if the search in the leaf nodes fails as described in more detail below. Now, the compressed ternary mask system and method in accordance with the invention will be described in more detail.

FIG. 2 is a diagram illustrating the searching architecture 40 in accordance with the invention that permits a more rapid searching of the contents of the CAM in accordance with the invention. In accordance with the invention, a very wide search tree as described below may be used in order to converge on a data match in a tree structure rapidly. A very wide search tree is also more economical with branching between 64 and 1024 ways at each level, depending on the size of the ultimate DRAM that contains the leaves. In this preferred embodiment of a 1M*64 CAM architecture, there is a 2 level B-tree structure that finds an index into a final “bin” or “leaf” which contains 64 entries in a DRAM. The 64 entries may then be fetched by address (i.e., the index is retrieved from the b-tree structure) and compared against the key so that the comparison occurs with only the 64 entries instead of all of the entries which significantly reduces the comparison time of the CAM in accordance with the invention. In the architecture, note that there is no “CAM-cell” memory structure in the large memory blocks, only SRAM and DRAM memory cells.

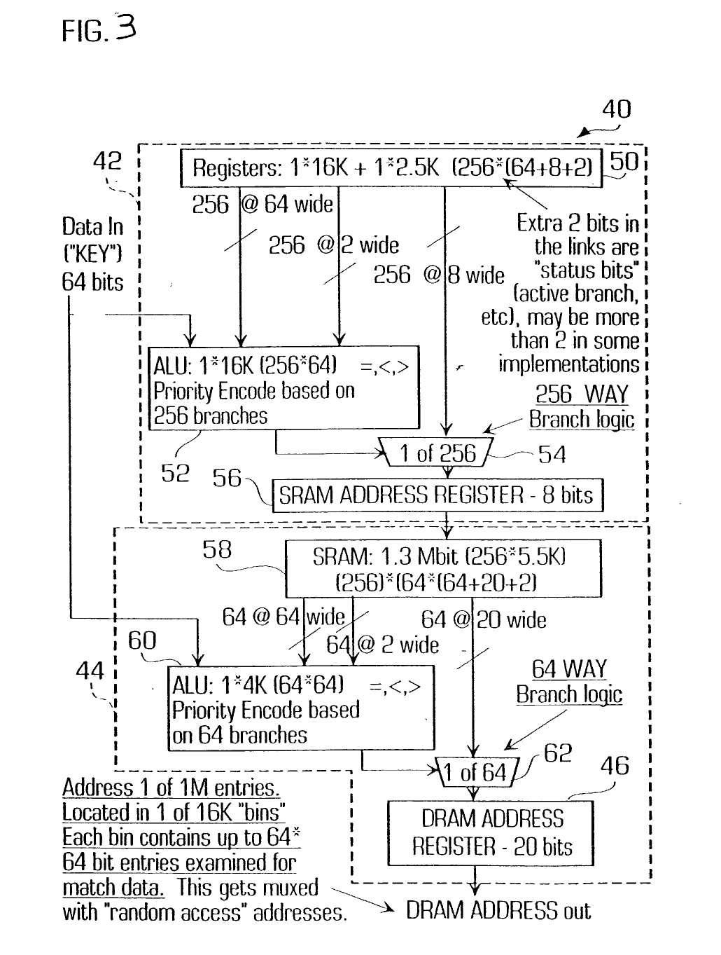

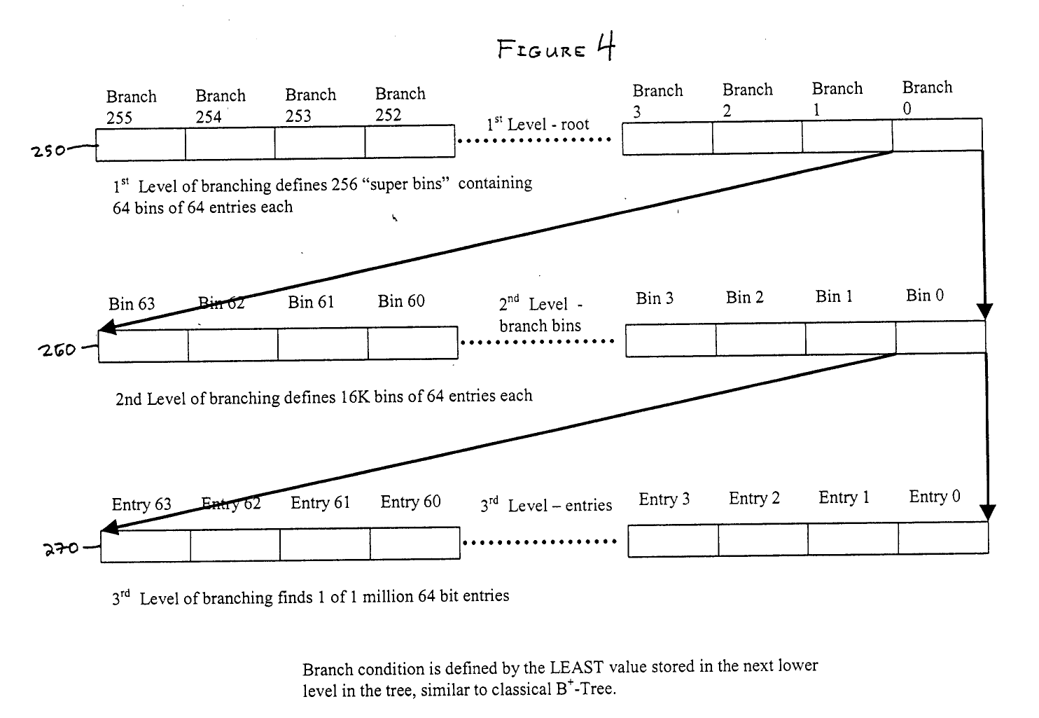

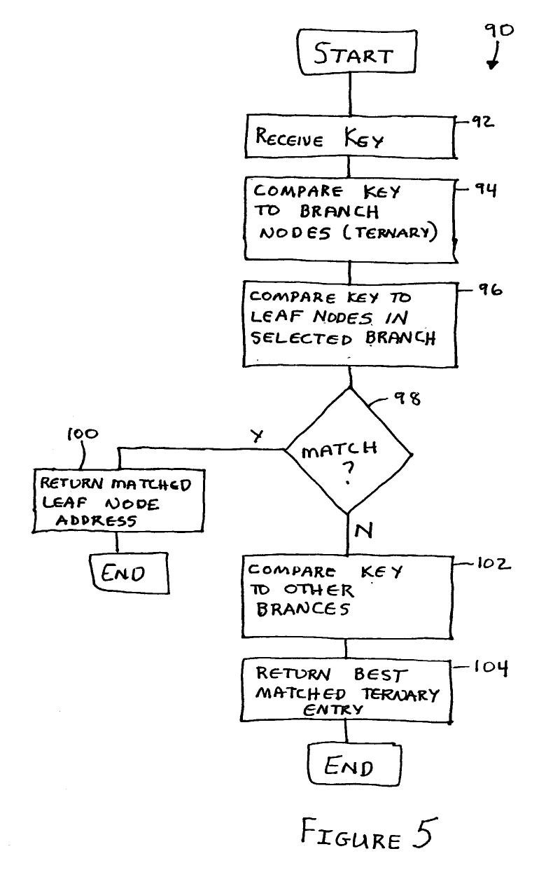

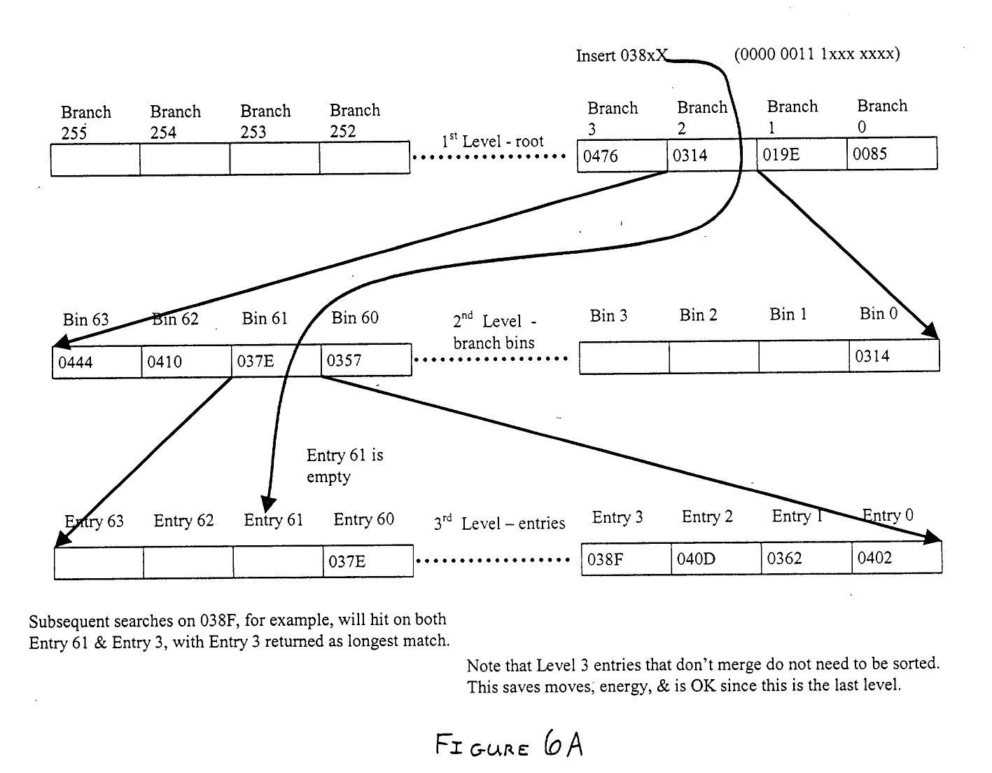

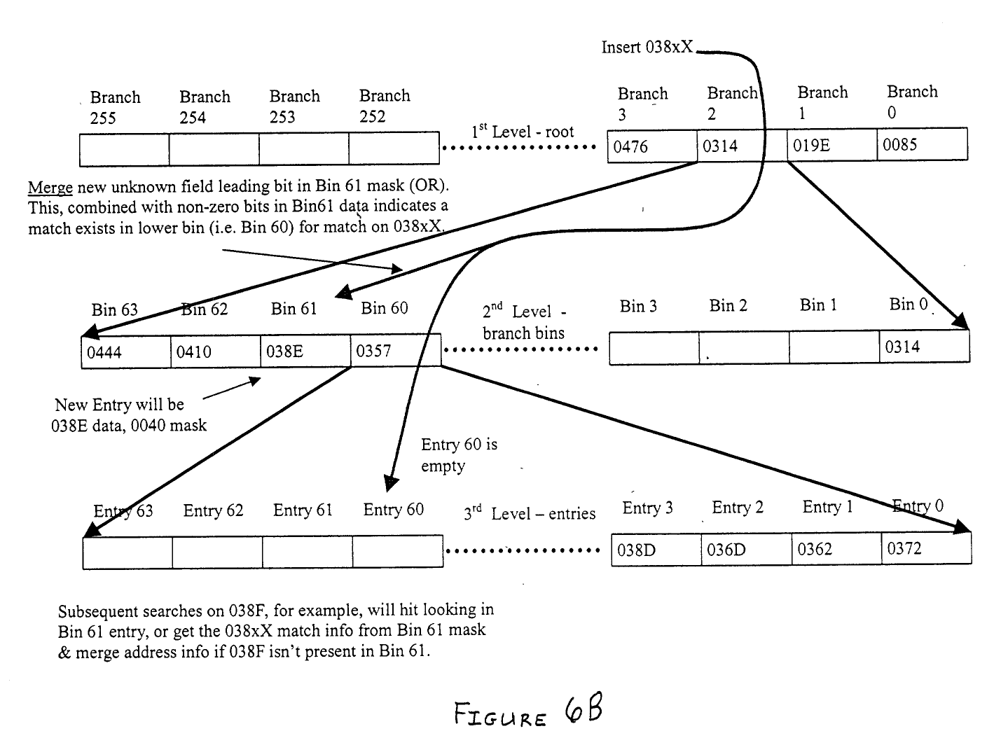

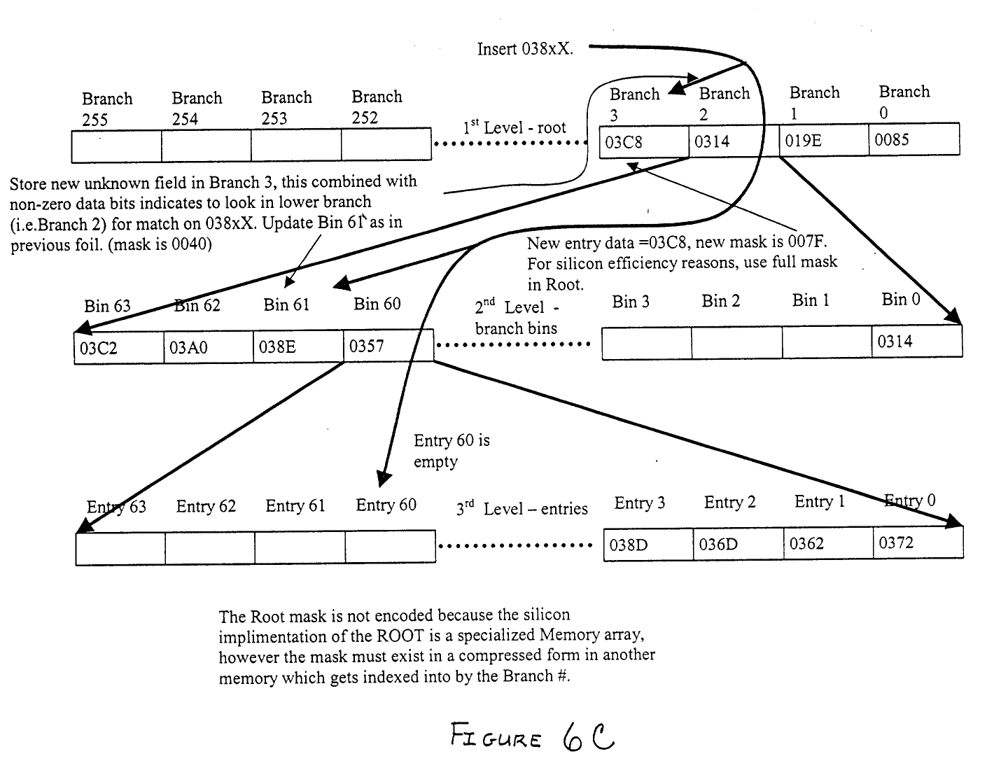

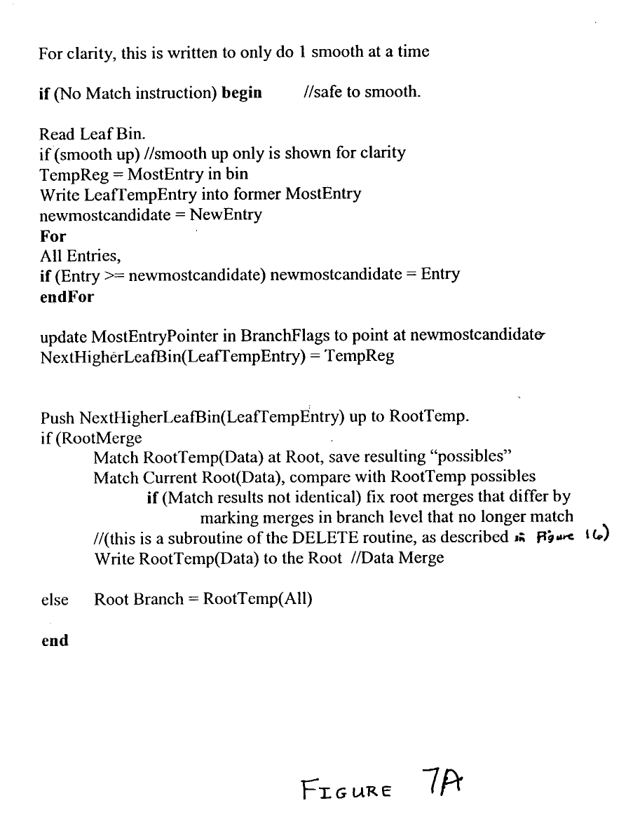

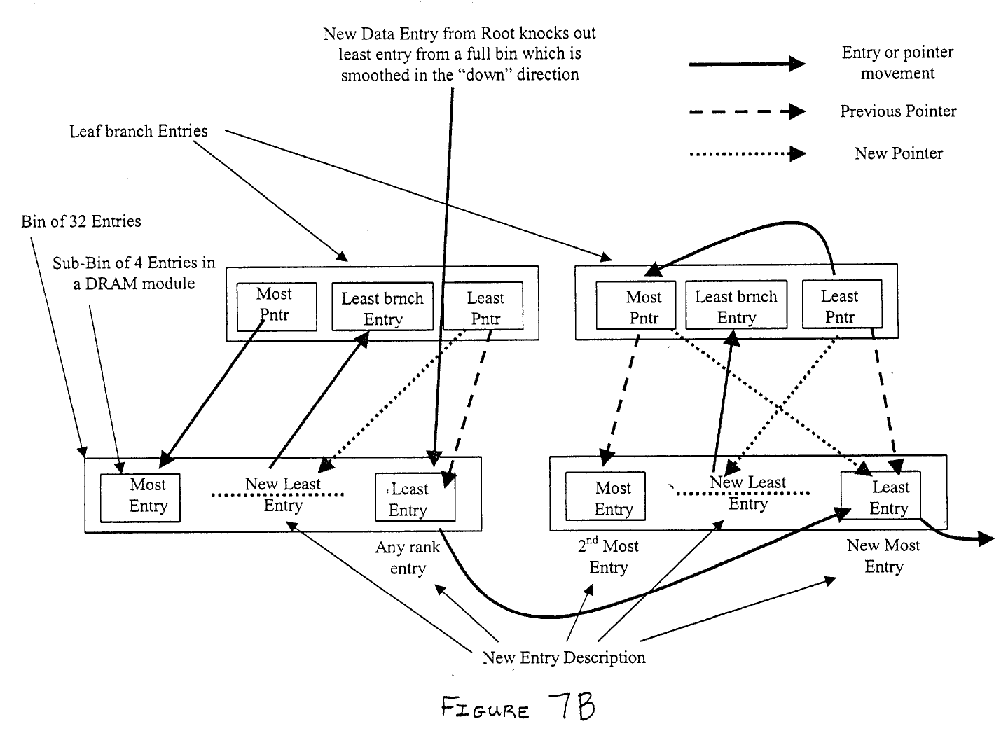

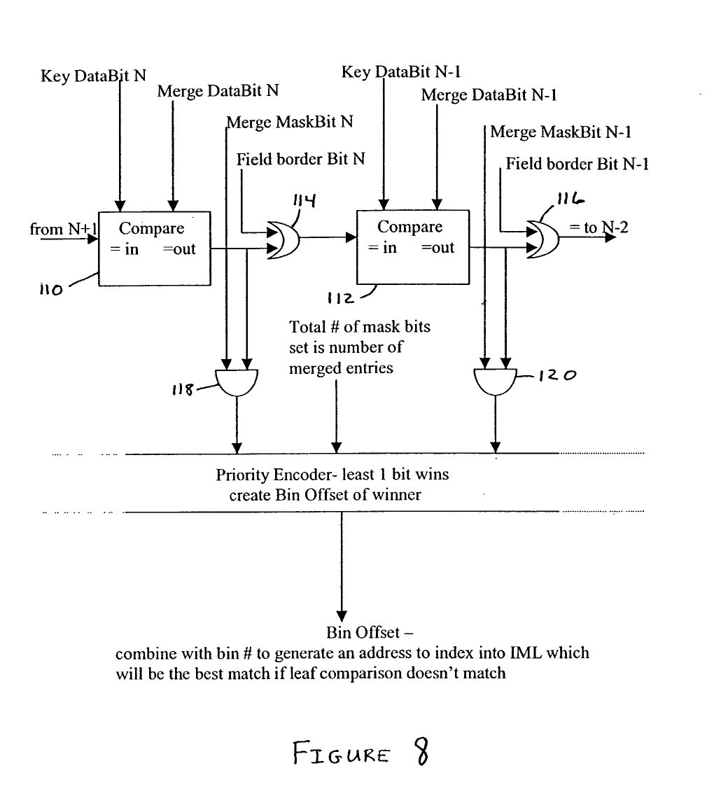

The architecture 40 may receive input data (a “key”) that may be 64 bits in the example of the preferred embodiment. In accordance with the invention, the key may be fed into a 256 way compare and branch logic 42 that compares the key to each of 256 groups of the memory to generate a single pointer to the next branch level. The pointer generated by this logic 42 may be fed into a 64 way compare and branch logic 44 which also is fed the key. This logic 44 may again compare the key to each of 64 groups within the selected group from the original 256 to generate a single selected memory pointer to a block of memory. In this manner, the number of full memory locations that are compared to the entire key is rapidly reduced so that the final comparison of the full key to memory locations may be completed rapidly. The structure of the compare and branch logic 42, 44 is further illustrated in FIG. 3.

The output of the second compare and branch logic 44 (the address of a small group of memory in the CAM) is fed into multiplexer 46. The APL signal from the AMR (during random access reads to the CAM) and a read/write address (the memory address for non-CAM random access reads or writes) may also be input into the multiplexer so that the output of the multiplexer is the address of a bin so that the MDR may function like a CAM and return an address of a matching memory location or may function like a RAM. During CAM operation, the multiplexer may output the DRAM address for a matching entry (memory location) in the CAM from the tree. In more detail, the DRAM address may be 1 of over 1 million entries (256X64X64 in this example) wherein the entry is located in one of 16,384 different memory bins as selected by the two compare and branch logic circuits 42, 44 as shown in FIG. 2. The actual number of bins and entries varies with different embodiments and depends on the actual branches performed by each circuit 42,44. In this example, each bin (selected by the two logic circuits 42, 44) may contain up to 64 64-bit entries that may be examined for a match. Thus, in this preferred embodiment, instead of matching the key against over a million entries, the key may be matched against 64 entries which significantly reduces the time required to perform the comparison compared to the time required for a sequential search of the DRAM and significantly reduces the circuitry required to perform the match compared to the circuitry required in a traditional CAM (by a factor of a constant multiple of 16384 in this instance or, in general by a factor which is a constant multiple of the total memory/branch bin size).

The advantages of the wide tree structure are three fold. First, the ratio of storage in the tree is very low (in terms of number of bits) in relationship to the final data storage since the comparisons at each level can be performed in parallel across 4-64K bits of comparator logic for speed.

Each branch in the tree has an associated Key value that defines the least bounding value for the subsequent branches or leaves underneath that branch and the address pointer to the next node in the tree, or the final leaf or “bin” of data. The method for inserting the entries into the tree may attempt to keep the number of branches at each level to less than ½ the maximum until all subsequent levels in the tree are similarly filled to at least ½ capacity. This insertion method should leave plenty of room to insert data into each bin without excessive collisions until the memory is more than 63/64ths full (i.e., 64=the # of elements in a bin.). A description of the corner case where the memory is “almost full” is provided below in connection with an insertion and smoothing method in accordance with the invention. Now, the hardware that may be used to implement the search tree architecture shown in FIG. 3 will be described in more detail.

FIG. 3 is a diagram illustrating an example of a hardware implementation of the search architecture 40 that includes the first branch logic 42, the second branch logic 44 and the comparator/DRAM address register 46. In more detail, the search architecture may include a set of registers 50 that store the AMR data and thus include two extra bits in the links that are the status bits indicating an active branch or not. This register memory, combined with ALU 52 may be organized as a small special CAM, with SRAM cells for memory instead of registers.

A comparison of the 64-bit key and the branch data from the register 50 is performed in 52. Each branch value from 50 is compared for greater than or equal to the key. The results of the comparison are priority encoded based on the possible 256 branches at this level of the tree (with larger branch number having higher priority). The status bits suppress inactive branches from participating in the comparison. The output of the ALU may be fed into a multiplexer 54 that selects the 8 bits pointer corresponding to the highest branch that compared greater than or The output of the multiplexer is a selection of one of the 256 bins at this level and its associated address. The output of the multiplexer may be stored in a SRAM address register 56 that may be 8-bits in size in this embodiment. The address stored in the register may be used to retrieve data from an SRAM 58.

The output from the SRAM may then be fed into the second branch logic 44 along with the key. The branch logic 44 may further include an ALU 60 that performs priority encoding based on the 64 branches at this level and outputs the resulting data. The resulting priority encoded data and the data from the SRAM may be then fed into a multiplexer 62. The output of the multiplexer 62 is the address of the least entry of a 64 entry bin and the address may be stored in the DRAM address register 46 so that the DRAM address may be output.

The above embodiment is merely an example of a device that may be implemented in accordance with the invention. For example, the “N” in each N-way branching logic is clearly flexible and can be tailored to fit the needs of the target DRAM memory and the ultimate size of the DRAM array. Thus, some implementations might make the branching number lower or higher than indicated here.

In some embodiments, the multiplexers & associated SRAM bits (8 & 20 respectively) will be replaced with simpler and smaller logic that simply encodes the output of the priority encoder into an 8 or 20 bit (16 bits plus 4 trailing 0 bits to define a bin) value, eliminating a level of indirection. This may be acceptable in many cases, and will have superior area efficiency.

In the embodiment shown above, a “Nearest search” closeness based on 2-s compliment size is clearly very robust in this scheme. Once a key has found the best candidate bin, if an exact match was not present, the entries in that bin could be examined to find which was closest. This could either be accomplished by examining all entries in parallel, or in the case where the entries in a bin have links (6 bits in this case of a 64 entry bin) which indicate the ordering of the entries, performing a binary partition search to find between which 2 entries the key falls.

In accordance with the invention, it is possible to arrange the CAM circuitry in accordance with the invention to perform 128 bit CAM operations, or any other desired size, by additional pipeline stages in the ALU operation or by running the branch stages at a slower rate if that is required. This may also be configurable based on a status bit. In accordance with the invention, the efficiency of this search architecture improves as the data match (key) gets bigger since the overhead of the AMR becomes a smaller percentage of the total memory space. In addition, by using the association address (the address where data is stored—the IML) as a further pointer to data stored in the portion configured as conventional DRAM, the efficiency of the architecture is improved even further.

The memory in the branches will be DRAM in many embodiments or the final “look up (leaves) bins” could conceivably also be SRAM. This disclosure is anticipated to be the preferred way. Also, the detailed memory architecture below is not required for the basic algorithm to work, albeit with less speed or energy efficiency.

The invention may be used for a variety of applications where the speed increases due to the search system and method is particularly beneficial. For example, the invention may be used for image processing, pattern recognition, data base mining applications, artificial learning, image recognition (satellites, etc), IP address routing and lookup, and routing statistics for networking applications and voice recognition both in mobile/desktop computers. In addition, DIMMs in accordance with the invention as described above may be used in server farms and central office for international language translation uses and URL matching. Further, the invention may be used for disk/database caching, multi-media applications (e.g., compression algorithms) and scientific simulations.

FIG. 4 is a diagram illustrating an example of the basic data structures in the branches and bins of the memory device in accordance with the invention. The diagram illustrates a first level of bins 250, a second level of bins 260 and a third level of bins 270. As described above, the first level of bins defines 256 super bins which each contain 64 bins themselves of 64 entries each. The second level of bins 260 may be selected by a first level of bins and each second level bin may contain 16K bins of 64 entries each. The second level of bins 260 each point to a set of 64 entries that may then be compared to the key as described above. Thus, using the search tree in accordance with the invention, the memory device rapidly searches through 1 million 64-bit entries.

As described for the strictly binary case, the correct leaf node to look in for a possible match to a supplied key is found by successively following branches such that the key falls between (as an unsigned binary comparison) the value defining the branch followed and the branch immediately higher. That is, the branch values divide up the number space into subregions which are then further sub-divided by the next level of the tree into still smaller regions.

If we examine the definition of “SV0”, this is the lower end of the range of values defined by the masking scheme, and also is equal to the actual binary value of the data stored. It is important to note that entries can be legally completely unmasked, or binary. Let us postulate that an existing tree structure exists, composed of binary values dividing the number space, as mentioned. Generality is not lost since an arbitrary “equal subdivision” of the number space can be used as “starting branches” for a tree. There are several possibilities for a new ternary (masked) entry, as it is inserted into an existing tree that has been built up and those possibilities are:

1) The new entry is actually binary, in which case this new entry is inserted in the appropriate leaf bin (i.e., the leaf bin which has branches that are lower and higher binary values compared to the new entry;

2) The new entry is a ternary entry, such that the entire range of values defined by it's split values (SV0 & SV1) fall between the values of the existing branches, and thus a leaf node can be unambiguously determined for the new entry; or

3) The new entry is a ternary entry, such that the range of values defined by SV0 and SV1 fall in the number sub-regions defined by 2 or more of the existing branches.

It is apparent that cases 1 and 2 are straightforward since the new entry is simply inserted into a leaf node and we move to the next operation. Case 3 is the “hard case” that the compressed ternary mask compression in accordance with the invention solves.

To implement the compressed ternary mask compression and perform a tree search on ternary entries, it is desirable to have information about the entries' masking residing in the tree branch nodes to assist the search. A convenient representation for mask values in the tree is the single “1” bit of the “edge extracted” mask, because masks from multiple entries can be represented in a single mask word in the tree. That is, as a search is conducted, all unique mask values present in the next level of the tree can be represented in one memory access to a mask value. In our case described here, all 32 possible mask lengths associated with a branch value can be determined under the assumption that we have “OR'd” all the edge extracted values together into one tree memory location. If there are no duplicate entries in the leaf memory, then there is one unique branch entry or leaf entry associated with each mask size (i.e., each edge extracted bit weight).

An example of this edge extracted mask in accordance with the invention will now be described. Suppose that the data portion of three adjacent 2^{nd} level branches of a tree are defined by the binary values 12345600, 12345688 and 12345940. In other words, all database entries with data component between values 12345600 and 12345688 are stored in the leaf bin associated with 12345600, etc. Further suppose that two of the entries that are stored in the leaf bin defined by 12345600 are 12345600/000000FF (data and mask) and 12345680/0000007F (data and mask). These values “overlap” both of the branches 12345600 and 12345688, and the question is how to retain this information in the tree when a key search is performed. In accordance with the invention, both of these masks can be represented by the single value 000000C0 (i.e. the OR of 00000080 and 000000040 which are the edge extracted values of the masks). The novel method associates this compressed and OR'd mask with the branch immediately higher than the leaf bin in which the entries are stored. So, in this above example, the branch 12345688 would have an associated mask information of 000000C0. This mask information would allow key searches for key values between 12345688 and 123456FF (the SV1 of the 2 values) to know that there was a match in the next lower leaf bin if there wasn't a better match in the 12345688 leaf bin. The branch entry with the 000000C0 mask is called a “MERGE” for obvious reasons. Now, a method for compressed ternary mask searching in accordance with the invention will be described in more detail.

FIG. 5 is a flowchart illustrating a method 90 for compressed ternary mask searching in accordance with the invention. An example will be provided while describing the steps of the novel method. A key value to be searched is received in step 92. For example, suppose a key value of “12345689” is supplied. In step 94, the key is compared to all of the branch nodes of the search tree. In this example, there may be three branch nodes (e.g., three adjacent 2^{nd} level branches of a tree are defined by the binary values 12345600, 12345688 and 12345940). Therefore, the key is compared to all three branch values and the branch value “12345688” is selected since the key value is greater than the branch value, but less than the next branch value. Once that branch is selected, the key is compared to the values located in the selected branch bin in step 96. In step 98, the method determines if a match occurred during the comparison of the key to the values within the bin defined by the branch value. If a match did occur on a leaf entry (see step 100), the match value would be known to be the best match (that is, the entry must naturally have a smaller masked range in order to “fit” in a leaf node, therefore it has more unmasked bits that match, making it the “best” by our previous definitions.) and the matched leaf node IML address is returned as a result and the search has been completed since the best match has been located and returned to the user.

If there is no leaf match in the selected branch, then the best match in the tree is returned by comparing the key to the other branches in step 102. In step 104, the best masked match in the tree is returned. In the example, the returned match would be “12345688/00000040”, which corresponds to the leaf entry of “12345680/0000007F” in the leaf node defined by branch “12345600”. Notice how the tree branch comparison “ignores” the masked “1” at bit weight 8. Also notice that ternary matches in the tree occur on data/mask information for branches that are LOWER (smaller binary value) than the branch the binary search takes down the tree. In accordance with the invention, several data/mask branch entries could match the KEY, but the branch that is Highest (largest) will be the best match because it will have more unmasked bits in common with the key than lower branch values will. In this method, each level in the tree can return the match, that is, as we refine the search region, we are also “saving” the “best example” that has been discovered so far in upper levels of the tree. To reiterate, this method combines a binary tree search to refine the search range successively at each branching level of the tree, while IN PARALLEL performing ternary equality searches on ALL the compressed mask values of overlapping leaf entries present in the branch(es) that were fetched at the same time as the winning branch.

In the above example, a three level tree for this discussion (i.e. root, branch, leaf). However, by recursively applying this mask compression at each level in a tree structure, any depth tree structure may be used and the method can unambiguously represent all possible matches for any presented key in the tree. In accordance with the invention, only mask information for entries that overlap more than one branch (as defined by the SV0 & SV1 endpoints of the entry) at that level in the tree are placed into the tree. If an entries' split value range fits entirely within a branch, it's mask DOES NOT participate in the compressed mask entries at that level, since the binary search will follow that branch if there is a possible match to the key. By applying this rule, it is straightforward to see that there can be at most “n” entries with masks that participate in the compression at any particular branch level, where n is the number of bits in an database entry (in this case 32). If more than one level of the tree returns a match, then the level in the tree that is Lowest (i.e. most non-masked significant bits) is always the best, so the selection process is simply return the last match that occurs as we traverse down the tree from root to leaf, with the highest matching branch at each level winning multiple branch matches. Now, an improvement to the insertion time for the search method in accordance with the invention will be described.

FIGS. 6A-6C are diagrams illustrating examples of the data entry tree insertion method in accordance with the invention. In these examples, only 16 bit entries are shown for clarity. FIG. 6A illustrates new data entry when the entry fits into a bin. FIG. 6B illustrates new data entry when the entry overlaps a bin and FIG. 6C illustrates new data entry when the entry overlaps at the root level. As mentioned already, the application is inserting data without regard to whether there is room ‘locally’ in the tree. That is, even though there may be room in the memory at the IML, when that maps to an actual leaf bin in the tree structure, the leaf may be full and require “moving” entries to neighboring leaves and changing branches to reflect the new boundary values. Leaf bins are fixed in the preferred implementation since pitch matched or other fixed resource hardware is designed to compare a fixed number of entries each cycle. This means some schemes that can allocate different sized leaf nodes, that are used by software tree searches aren't practical here. Since all leaf entries in a node are compared in parallel, it is not required to sort them, and this can save a large amount of time in the worst case. This is true because the only items in a leaf node are 2 entries, the “least entry” and the “most entry” which define the endpoint values of that leaf. These can be in any address location with the leaf node (bin) as long as there are pointers set up to indicate which address they are at. Now, a smoothing method to reduce the memory accesses to move entries in a tree in accordance with the invention will be described.

FIG. 7A is a diagram illustrating pseudocode for a preferred smoothing up method in accordance with the invention and 7B is a diagram illustrating an example of a down smoothing method in accordance with the invention. For the pseudocode shown in FIG. 7A, the variables shown in FIG. 7A are described in more detail in the description below. The method reduces the number of the memory accesses required to move entries between leaves to just one read/write cycle. In particular, the entries “kicked out” of a leaf node into the neighbor will either be the least or the most entry of the neighbor node.

First, the case where a least entry is becoming the most entry in the next lower leaf bin is described. In particular, if that bin is not full, then we are done and the new most entry gets put in an empty location and gets pointed to by the “most pointer”. However, if the neighbor is also full, then the least entry in the neighbor bin will get moved out as well. Since the only entry that has to physically vacate the leaf bin is the old least entry, move it to a holding register and put the new most entry in it's place. Then, change the most pointer to point at the old least location, find the new least entry and change the least pointer to point to it. Since all these entries and pointers are fetched in parallel in one memory cycle, all information required to perform these functions is available per cycle. Since the actual data movement is minimized, the hardware bus resources to perform this is not “n” entries wide (n is number of entries per leaf bin), but only 1 entry wide.

By not sorting within a leaf bin and changing pointers instead of entry locations, we reduce the potential number of memory cycles by at least a factor of “n”. Therefore, the worst case time to make room for an inserted entry is 10's or 100's of microseconds in today's technology instead of potentially many milliseconds. This difference makes this method practical in real-time applications for networking at leading edge data transmission rates, and saves a significant amount of worst case energy that would be required to move more entries. In actual practice and in an actual implementation, extra state information will be kept to indicate whether to move entries into lower bins (“smoothing down”) or upper bins (“smoothing up”) based on which direction from the current bin will cause the least adjustment to the tree. In addition, “smoothing” will run as a background task to eliminate “full” leaf bins, thus reducing average insertion time to close to a memory cycle. Since insertion accesses compete with key searches, it is important to minimize re-writes of entries. Now, a novel extension to the concatenated field matches in accordance with the invention will be described.

In particular, instead of viewing concatenated fields as independent variables (which they mathematically are in the general case), let's view the concatenations as a single variable space, which means that the membership regions of the defined masked entries are disjoint collections of line segments along the number line defined by this new variable. In the sub-set case of a single field, masked versions of the same binary value “nest” within each other, greatly simplifying the tree search. Since, in the general case, each field does not (necessarily) create nesting regions for the same (masked) binary value, it is mathematically impossible for a tree search to converge on a “best match” by examining only 1 leaf node. Entries that overlap branches may overlap non-contiguous branches, breaking down the possibility of a one cycle resolution. Despite the above, a simple extension of the core method can drastically reduce the number of candidates in all but the most exotic corner case, and we can view the tree search as a filter the output of which a more intelligent (programmable) algorithm can apply one of several methods to, in order to determine the “best match”.

It is easy to modify the comparison hardware to break the comparison into many shorter longest match comparisons that run in parallel. These comparisons will produce a “best match” in one cycle, if the most significant field is the least masked of the fields, and has the highest priority of the fields in terms of match “goodness”. This can usually be arranged by breaking the tree into several sub-trees based on ordering the fields by how masked the entry is. This in no way solves or accelerates the worst case corner, but greatly accelerates the “typical” case and corner cases can be handled by slower or more memory intensive algorithms. These will not be described in this patent application, only the hardware to break the comparison is described below. (Simply returning all possible matches to the post processor would be a huge advantage for most databases). Now, a preferred example of hardware and logic for the compressed ternary mask method will be described.

FIG. 8 is a diagram illustrating an example of a portion of the preferred logic that may be used for the compressed ternary mask comparison method. In particular, the logic shown compares two bits of key data and mask data. In an actual system, such as a 32 bit system, the above logic would be replicated sixteen times. The logic comprises a first comparison circuit 110 and a second comparison circuit 112 wherein the comparison circuits may, in a preferred embodiment, be a exclusive not OR (XNOR) gate and an AND gate. The logic may further comprise a first OR gate 114, a second OR gate 116, a first AND gate 118 and a second AND gate 120 as shown. The outputs of the AND gates are fed into a well known priority encoder. As shown, the results from a prior data bit (N+1) are fed into the first comparison circuit 110 which also receives the Nth bit of the key (Key DataBit N) as well as the Nth bit of the compressed mask (merge Databit N). The output of the comparison circuit is fed into the first OR gate 114 and the first AND gate 118. In the OR gate 114, the output of the comparison circuit is ORed with the field border Bit N (the bin values) and the result of the OR operation is fed into the second comparison circuit 112 which operates in a similar manner and therefore will not be described herein.

As described above, the 2^{nd} level branching in the tree uses a compression scheme for storing the merge information in the mask field of the next higher bin. As entries are written into a bin at the leaf level, if the SV0 & SV1 are different, the leading 1 bit in the mask is extracted and ORed with the mask in the next bin up. This compresses potentially as many masks as there are entries in a leaf bin into 1 mask word at the 2^{nd} level. This works for concatenations of ternary fields as well, as long as each field obeys the longest match paradigm. Arbitrarily masked fields must be decomposed into multiple entries, for typical usage this should be low enough number to be practical.

To extract the matches against all the possible entries in the merge bin, while not being required to access the leaf memory, a simple technique can be employed. In particular, the comparison should be strictly a binary comparison, each bit of which is gated by a bit in the compressed mask using an AND function as shown in FIG. 8. At each bit in the comparison, the compare result represents whether an binary equal match is present above that bit position. (In implementation, this is achieved by a ripple down circuitry, with perhaps a look ahead to speed up resolution for speed). So, for each mask length, the result of the AND gate exactly encodes the result of a comparison against the actual leaf entry that produced that mask bit in the merge mask. Below that bit position, the comparison is a don't care for that leaf entry. Note that the AND function is in addition to the equality function, and does not interrupt the computation of equality at the AND. This let's the same equality comparison be used for all mask values. The results of the individual AND functions are prioritized, with the LEAST bit value as winner. In combination with the fact that entries in a leaf bin that participate in a merge are stored in physical address order in the bin according to the amount of masking (see the example pseudocode described below), the physical address of the winning MERGE entry can be used to retrieve the IML of the “best match” if the LEAF bin access (which can be pursued in parallel since it uses an unmasked binary compare circuit to pick a branch) does not produce a better match.

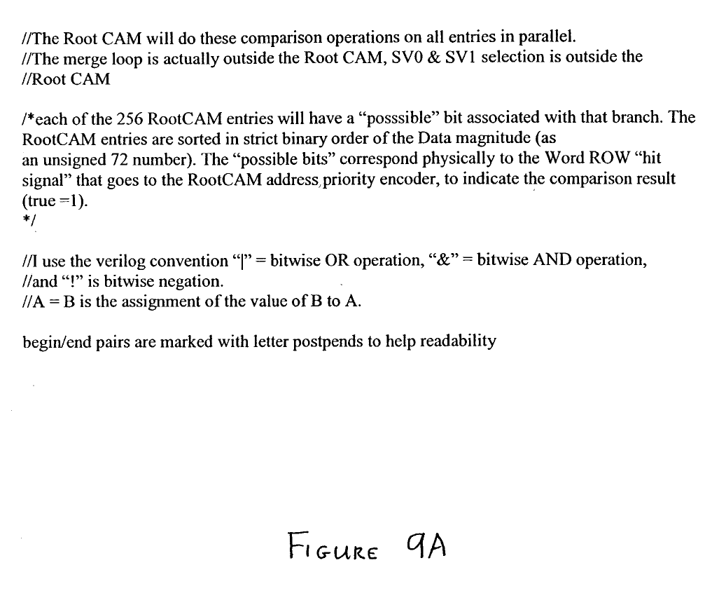

If the concatenated fields described above are being used, the logic shown in FIG. 9 may be modified slightly. In particular, the assumption at this point in the circuitry is that quality of match in the first 2 fields is the determining factor for best. Since the masks are encoded at the second level and the assumption of merging is that “buried 1's” don't have meaning for the merge equality comparison, if we neglect to indicate to the circuit where the field boundaries are, many false comparisons would be generated. However, if the equality comparison is CUT at the field boundaries, and each field produces an equality comparison on it's own, then leading 1's in the fields will be correctly evaluated if they are above the mask bits in bit value in that field. The circuit to cut the equality comparison is simply an OR inserted (see OR gates 114 and 116) at the bit weight corresponding to the boundary between 2 fields which will force the lower field to start with a forced “equal” at it's top bit. This OR will, of course, not be active at bit positions that aren't field boundaries (as defined by the application), and so will not affect the comparison internally to fields. Now, the extraction of a leading “1” bit for each field of a mask in accordance with the invention will be described.

The extraction of the mask leading bit can be accomplished in a very straight forward way by using an XOR gate (a well known exclusive OR function) each of the mask bits with it's neighbor, and the only bit weight that results in a 1 is at the border between 0 (no mask) and 1 (mask). This works only for longest match fields, with the masking associated with the least bit weight fields, which is the target application for this circuit. For concatenated fields, the trailing edge masking edge between 2 fields needs to be suppressed by the field border bits supplied by the application. Now, a detailed pseudocode example of a preferred embodiment of the compressed ternary mask searching method in accordance with the invention will be described in more detail.

The pseudocode described below is an example of a preferred implementation of the compressed ternary mask method into a particular hypothetical hardware solution. The details of the embodiment described herein may change in each technology node based on efficiency of memory granularity & achievable memory density. The novel method is a tree search which is fixed at 3 deep in this implementation, but could be extended to a tree that has any number of levels and depths. The search method is unique in that it successfully resolves best ternary matches without multiple memory cycles at any stage of the tree and resolves a ternary database with strictly binary comparisons in the tree for branch resolution. It is deterministic for longest match, after allowing a “tax” for refreshing the memory when the leaf memory is DRAM. This method presents an interface to the application using the Tree that appears to be a random addressable CAM, and so can replace smaller traditional CAMs in a wide variety of application uses. The tree in this example is organized as a VERY WIDE BRANCHING tree, which creates a high amount of leverage in the TREE to LEAF circuitry size. This results in a very large CAM compared to traditional versions with a comparator at every bit.

In this pseudocode example, a 128K*72 Ternary, longest match CAM with 256*16*32 bin branching is described, to further illustrate that the tree can vary in branching width and database entry size. In other words, 256 way branching in the ROOT, 16 way branching in the 2^{nd} level, and LEAF BINS that are 32 entries each are described. In addition, four Leaf bins, of 32 entries per leaf “bin” are fetched for each memory read cycle. In addition, all entries inserted into the CAM appear in a LEAF bin. For the description below, “searching” and “matching” are synonymous and “write” and “insertion” are also synonymous. “Association” is the address being searched for based on the Data KEY presented. Unless otherwise specified in the text, the term “branch level” refers to the 2^{nd} level in the tree, while “branching” refers to operations in both the ROOT & 2^{nd} LEVEL. Many operations specified as serial loops in the algorithm will be done in parallel next to the sense amps in the physical part. To better understand the below described pseudocode, the following definitions are used:

“IML”: “Intended Memory Location”. This is the address that the application wrote the data to. It is the association that will be returned during a match. This bit field is present in the LEAF. 17 bits wide (to specify 128K entries). Any level in the tree can produce a match, the LEAF returns it's IML for the matching entry as the resulting association being searched for. The Root & 2^{nd} level branch uses the LEAF IML memory to find & return their IML, if there is a MATCH in the Root or 2^{nd} level. This is described in the bit fields section below.

“APL”: “Actual Physical Location”. This is the indirect pointer to where the tree insertion actually put an inserted entry. For a read, the address from the application is used to address this memory, & the data out (17 bits) is the address the data being read was stored at in the leaf memory. This memory gets written to at the end of an insertion, with the address where the insertion happened, using the application address as the address to the APL memory. This is associated with the LEAF level only.

“KEY”: A binary 72 bit, unmasked (except globally) input. The memory will search for this number in the memory, against the masked (ternary) entries and produce the longest MATCH (i.e. the least masked) entry as a result. If no entry produces an exact match, then return “notValid” as an output. Mask bits present in an entry carry the meaning “this bit is an automatic match against the corresponding bit in the KEY”.

“SV0 & SV1”: “Splits Values”. These are the two values formed by alternately substituting 0 for all masked bits in an entry and then 1 for all masked bits in an entry. These are both used during the insertion process to make the tree, and the SV0 is also the actual binary value of the Data portion of an entry, if it is not a “merge” in the tree.

“MERGE”: This concept is the key concept which makes this algorithm work. MERGEs are entries stored in the ROOT & BRANCH, they never appear in the LEAF. A MERGE is composed of 2 (or more) entries from the LEAF. Two different operations can form a MERGE: “Data Merge” & “Mask Merge”. For any particular insertion, if the merge occurs in the Root, the Mask from the NEW ENTRY replaces the Mask in the Root Branch immediately above the branch selected by the SV0, if it is larger than the mask already there (“Mask Merge”). (Merging applies to both ROOT branches & 2^{nd} level branches). If the Merge occurs in the branch, the leading bit of the mask is extracted and OR'd with the mask already present in the 2^{nd} level Branch immediately to the right within the current branch bin. Data Merge only happens during smoothing, not insertion, and occurs when a leaf entry is deleted or moved that participates in the branching. For Data MERGE the new branch defining entry (the least entry) is moved up into the MERGE, if the condition for merging still applies after the deleted entry is gone. The MERGE may represent more than 2 leaf entries, such as when many entries with the same Data value, but different Mask values are stored in a leaf bin. The Merge represents the range of mask values present in the Leaf bin(s). This is described below in the Branch Flags section & as commentary in the description.

Leaf Entries have a Flag state which indicates that the Mask/IML was used to create a MERGE in the tree. Data entries that participate in a MERGE are least entries that define the branch and are specially flagged as well on the leaf. This Flag state is used to assist the Delete (Write over) Entry command, so that it knows that special processing of the Tree is required to remove all traces of the DELETED entry.

Condition used to detect that MERGE is required: During insertion, if the SV0 and the SV1 comparisons against the current branch values are not identical results, (doing a binary compare against the Data entry with each of SV0 & SV1) then a merge operation will be required.

For this example, we are assuming that the memory macros are available in width increments of 72 (e.g., 144, 288, 576, 1152, etc.)

For this example, the tree has particular data type bit patterns which then form the basis for the compressed ternary mask searching method in accordance with the invention. In particular, each leaf entry comprises 72 bit Data, 72 bit Mask, 17 bit IML and 2 bit Flags (LeafFlag). Each Leaf Bin of 32 entries has an additional 8 bits of flags per bin (LeafBinFlags) reserved for later use.

LeafFlag per entry flag meaning:

| | |
|---|---|
| 0- | notActive |
| 1- | Active, not a merge or Least Entry in Tree bin (meaning, may simply |
| | delete) |
| 2- | Active, is merged or Least Entry in Tree bin (meaning, must look |
| | in tree to delete) |
| 3- | reserved. |

Each branch entry of the tree comprises 72 bit Data, 72 bit Mask, and 13 bits Branch flags (BranchFlag). Each Branch bin has 16 entries, so 16*(13)=208 bits are required, this leaves 1152−208=974 bits for use by the Branch Bin as a whole. 144+80=224 bits are used for “Merge Information” on the root merge bin (this branch bin & next root bin to the left). This leaves 750 bits for temporary storage locations for leaf entries (“TempLeafEntry”) in the process of being smoothed. Note that this memory is duplicated since the ternary equality test and the binary equality test can occur in parallel.

“Merge Information”: 72 bits indicates which merge masks are valid, and 16*5 bits indicate per leaf bin the allocation of the 72 possible root merge entries at the leaf level. THIS INFORMATION IS ABOUT THE ROOT BRANCH TO THE IMMEDIATE LEFT (LOWER) of the current branch bin. (This is 5 bits to specify the offset in the leaf where the merged entries are stored, since they are not completely sorted.)

BranchFlag[2:0] meaning:

0—notActive

1—Active, not a merge

2—Active, is a merge

3—reserved

4—Learn branch

5—Active, not a merge, leaf bin full

6—Active, is a merge, leaf bin full

7—reserved

BranchFlags[7:3] meaning:

LeastEntry offset in Leaf Bin. This points to 1 of the 32 entries which contains the Least Leaf Bin Entry (smallest binary value, or the most masked of binary equivalent entries.)

BranchFlags[12:8] meaning:

MostEntry offset in Leaf Bin. This points to 1 of the 32 entries which contains the Most Leaf Bin Entry (largest binary value, or the least masked of binary equivalent entries.)

Each root entry comprises 72 bit Data, 72 bit Mask and 3 bits Flags (RootFlag) RootFlag[2:0] meaning:

0—notActive

1—Active, not a merge

2—Active, is a merge

3—reserved

4—Learn branch

5—Active, not a merge, branch bin full

6—Active, is a merge, branch bin full

7—reserved

The memory required for the tree is:

| | | |
|---|---|---|
| 4 Leaf Data Memories(“LeafData0-3”) | | ea 4K*576 |
| 4 Leaf Mask Memories | (“LeafMask0-3”) | ea 4K*576 |
| 1 Leaf IML Memory | (“LeafIML”) | ea 4K*576 |
| 1 Leaf APL Memory | (“LeafAPL”) | ea 4K*576 |
| 1 LeafFlags Memory | (“LeafFlags”) | ea 256*1152 |

(each of the 512 leaf entries covered gets 2 bits. The output of this
memory needs to be muxed accordingly, as do the other memories.)

| | | |
|---|---|---|
| 2 Branch Data Memories | (“BrnchData”) | ea 256*1152 |
| 2 Branch Mask Memories | (“BrnchMask”) | ea 256*1152 |
| 2 Branch Flags Memory | (“BrnchFlags”) | ea 256*1152 |

(a duplicate BranchFlags memory is required to resolve Root Merge
Matches in parallel timewise with the binary tree search. This is cheaper
in silicon area than performing the full edge extraction merging at the root)

| | | |
|---|---|---|
| 1 Root Data Memory | (“RootData”) | ea 256*144 |
| 1 Root Mask Memory | (“RootMask”) | ea 256*144 |
| 1 Root IMLFlgs Memory | (“RootFlags”) | ea 256* |
| | | (3 flags) |

(This is a small, specialized Ternary CAM to do Root comparisons in
actual IC)

Now, the example of the preferred compressed ternary mask method will be described in more detail starting with the root initialization method. During the root initialization method, pick every Nth branch, and mark it as “learn”. “N” default value is 2, but it is user definable. Branches not marked “learn” will not be used until all the learn branches are filled. This will let the tree “learn” the average data pattern, while leaving empty space for filling in. This will limit the average insertion time when the memory gets “full”, since there will be gaps to absorb the new entries without smoothing from one end of the tree to the other. Mark these branches between the minimum branch and the maximum branch (as defined by the branch number from 0-255). Default minimum branch is #0, default maximum branch is #255, but they are user definable. Making them user definable will let the user build up “sub-trees” that use sub-sets of the tree, which are confined to particular branches, and remain isolated with a “pre-pend” tag in the leading bits of the entry which will be used in searching, and keep the sub-trees physically segregated.). The 72 bit starting & ending values are equal to the branch number left justified as the default, but are user definable to be any two 72 bit values, with the user definable increment per branch usually set to evenly divide the space between the endpoint values. These values are unmasked.

Learn branches are used during write insertions by using the stored binary value as a guide for where to put new entries as the empty memory is filled up. Learn branches are ignored during match, since a branch that is still marked learn does not have any valid entries below it. Learn is the same as notActive for match operation. Root branches not marked Learn, are marked notActive. Once the transition from Learn to Active is made, Learn state will not happen again for that Root branch, until a reset event (that is, Active branches can only go “inactive” due to deletions.) Now, the 2nd level branch initialization method in accordance with the invention will be described in more detail.

The branch initialization method is identical to the root initialization, with some minor changes. The initial value is set to be identical to the root branch value that defines that branch bin of 16 sub-branches, and the increments are default set to 1/1 k, left justified into the top 10 bits of the 72 bit word, however this is user definable Instead of every branch being marked as learn, only every 4^{th} is marked, this will spread the entries into groups of 4 leaf bins, which is a natural organization to limit smoothing time. Branch level branches not marked Learn, are marked notActive. As for the Root, once the transition from Learn to Active is made, Learn state will not happen again for that Root branch, until reset. Now, the leaf level initialization method in accordance with the invention will be described.

The only initialization required of the leaf entries is to be marked as “notActive” using a bulk clear of the appropriate bits in the LeafFlagsMemory. Currently, this can be a bulk clear to 0 of the LeafFlags memory). Now, the insertion methods, the match methods and the delete method in accordance with the invention will be described.

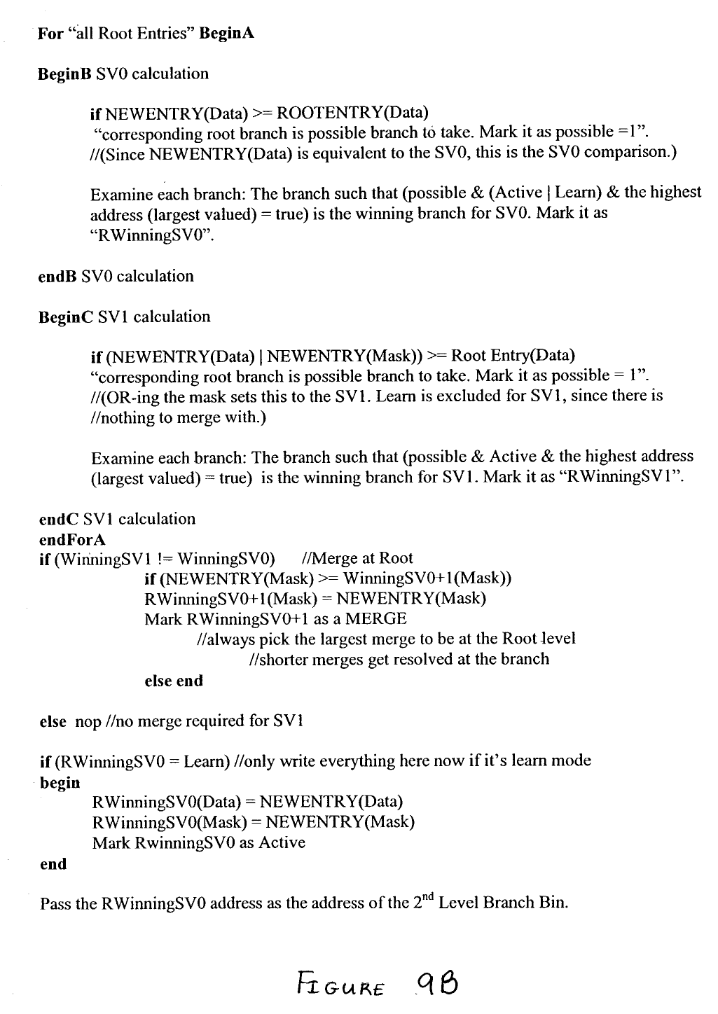

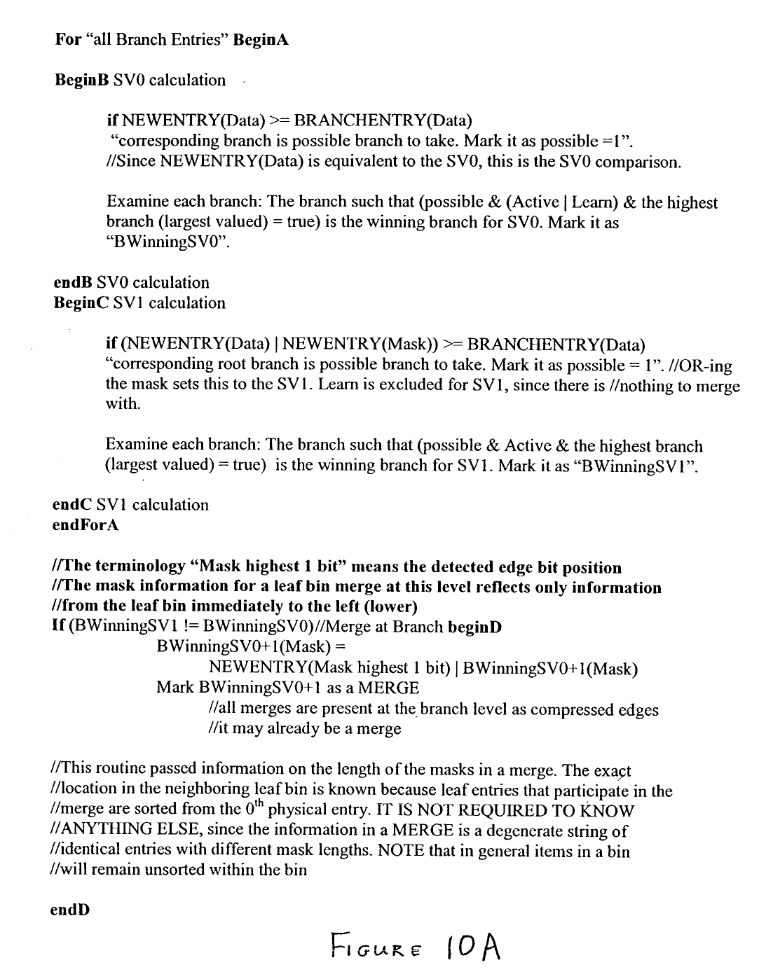

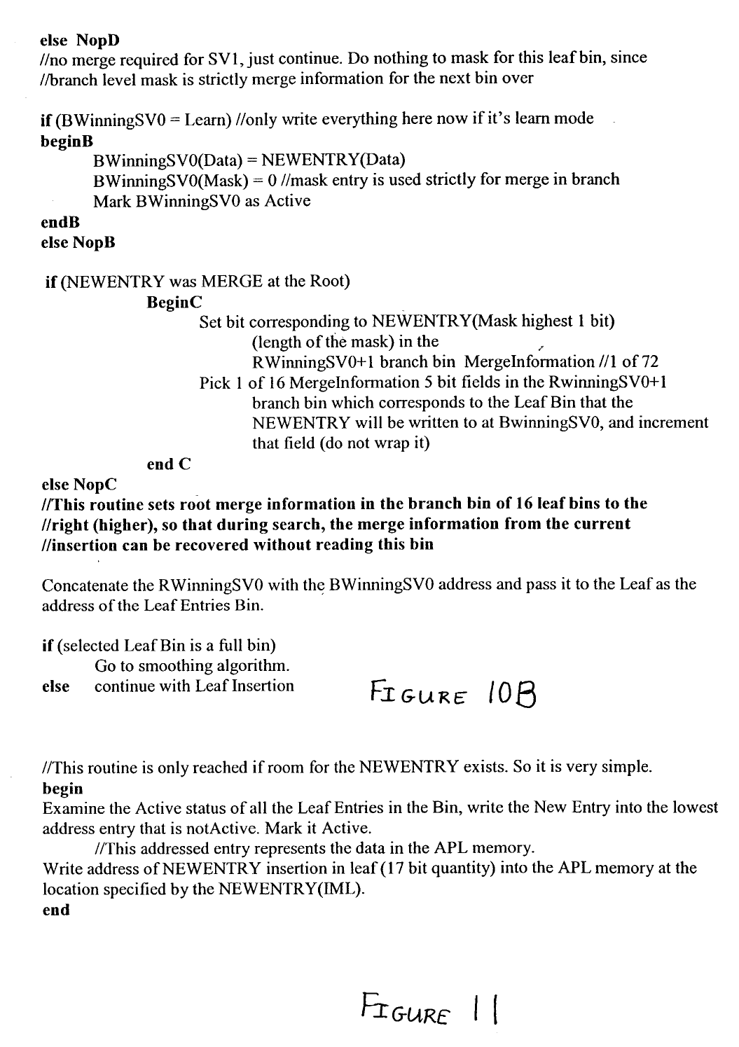

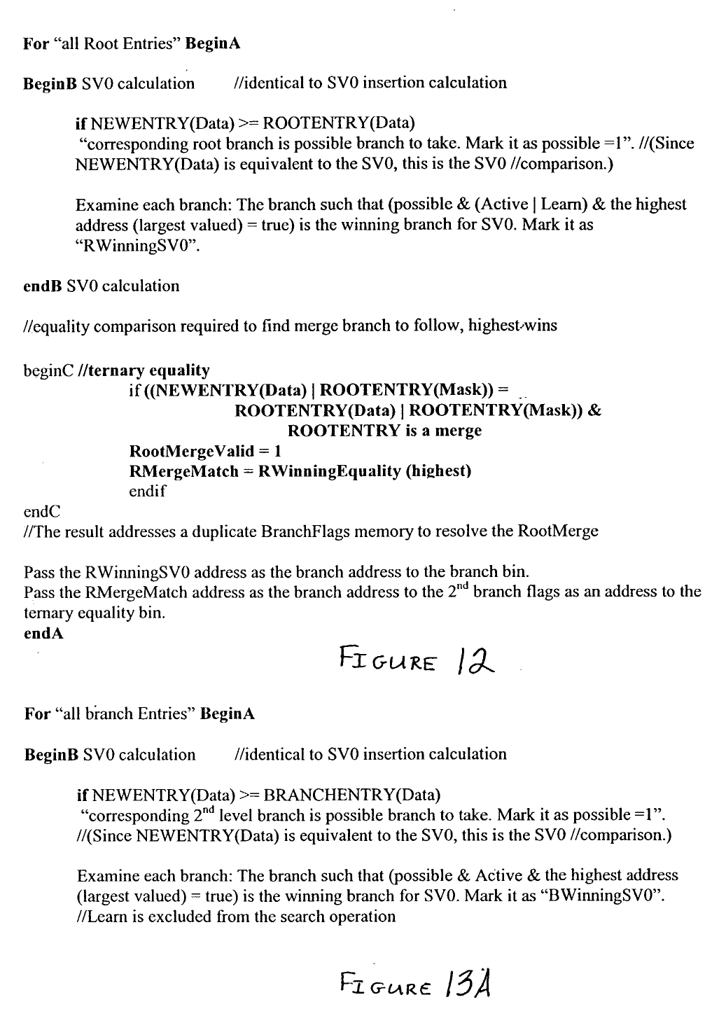

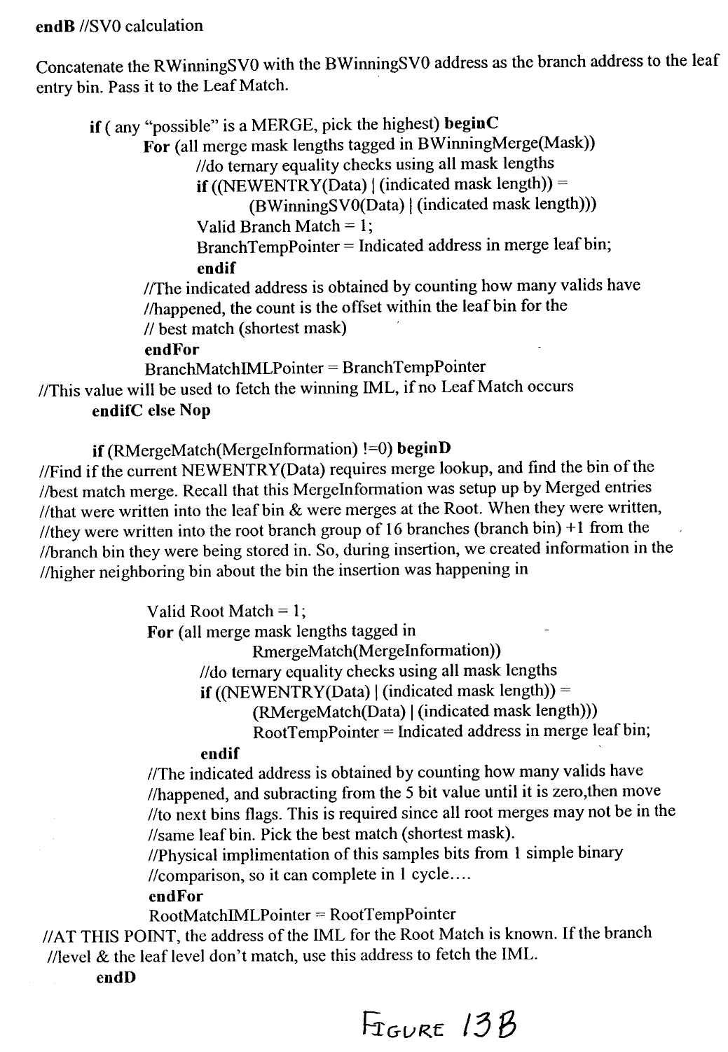

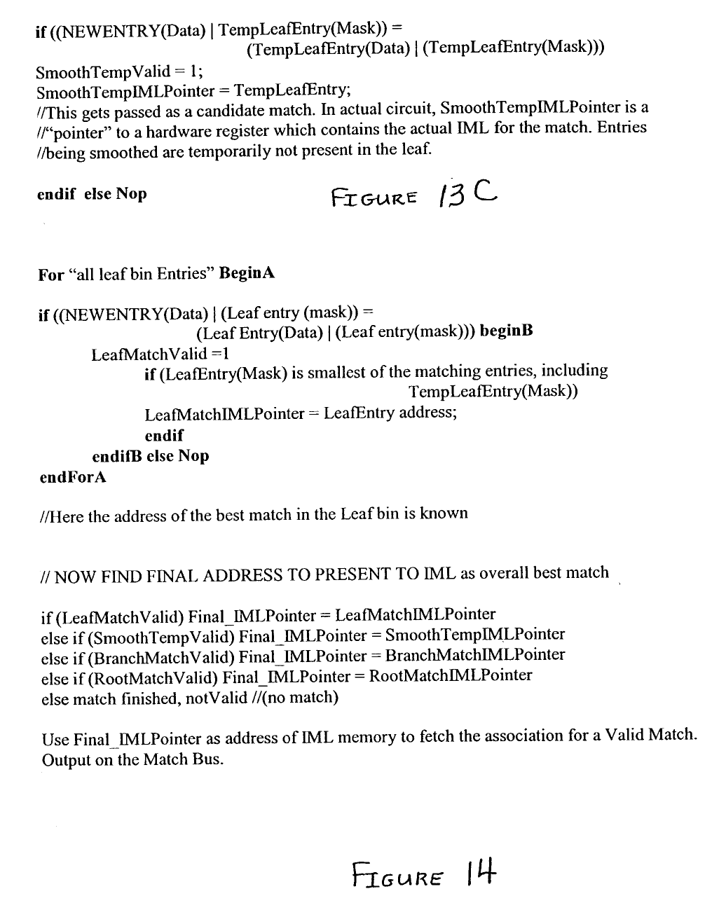

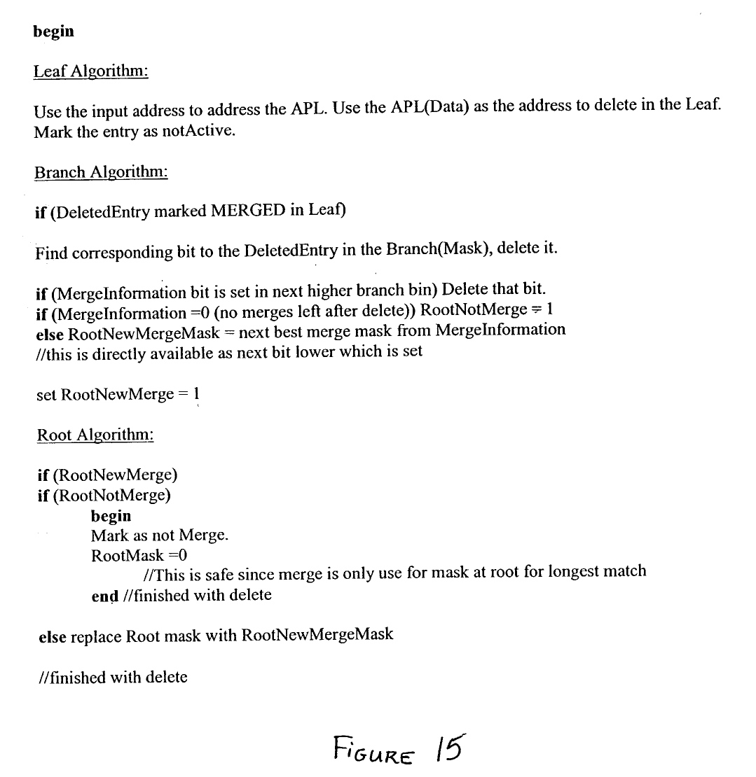

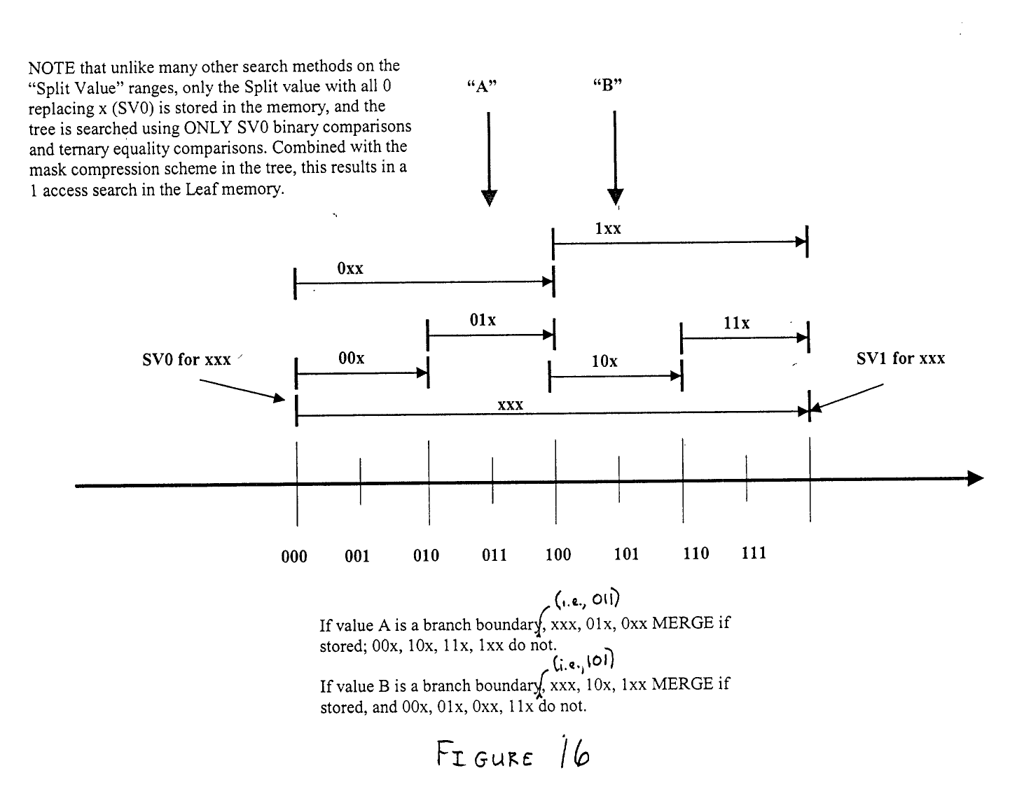

The method described herein typically are all be running in parallel at each level, except where flags are passed up from a lower level, and then sometimes there as well. In the pseudocode examples, the convention is used in which lower branches are to the left whereas FIGS. 6A-6C show the lower branches to the right. FIGS. 9A and 9B illustrate a root level insertion method in accordance with the invention and FIGS. 10A and 10B illustrate a branch level insertion method in accordance with the invention. FIG. 11 illustrates a leaf level insertion method in accordance with the invention and FIG. 12 illustrates a root level match method in accordance with the invention. FIGS. 13A-13C illustrates a branch level match method in accordance with the invention and FIG. 14 illustrates a leaf level match method in accordance with the invention. FIG. 15 illustrates a delete method in accordance with the invention.

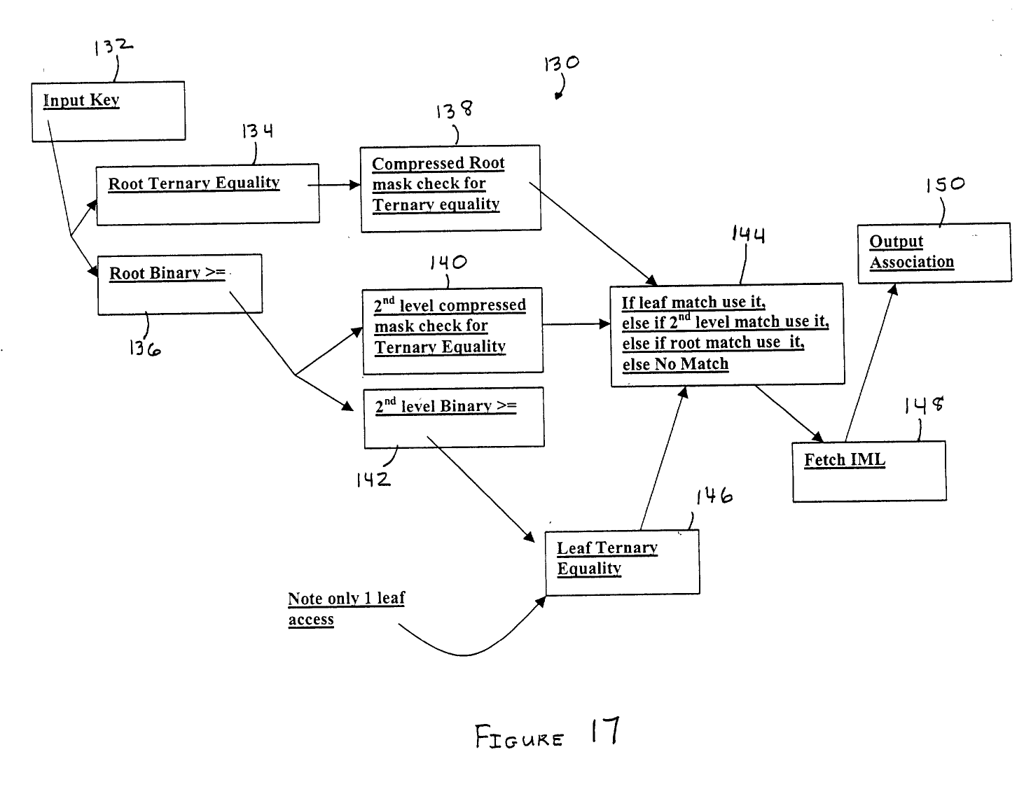

FIG. 16 illustrates the merge concept wherein multiple masks are merged into a single compressed mask so that a single memory access per search of leaf memory may be achieved. A simple tree bit number line is used for simplicity.

FIG. 17 illustrates pipelined execution 130 of the compressed ternary mask method in accordance with the invention. In particular, a key is input in step 132 as shown. In this diagram, steps which are vertically aligned may occur during the same memory cycle. Therefore, in a first memory cycle, a root ternary equality is determined in step 134 and root binary comparison in determined in step 136. In a next cycle, there are three actions which occur simultaneously. In particular, a compressed root mask check occurs in step 138, a 2nd level compressed mask check occurs in step 140 and a 2nd level binary comparison occurs in step 142. If the 2nd level binary comparison is true (e.g., a branch is the best branch), then leaf ternary comparison is tested in step 146. In step 144, if the leaf match occurs, it is used as the best match or the 2nd level compressed match is used or the root level compressed match is used or there is no match. In step 148, the IML of the match (if there is a match) is fetched and an association is output in step 150 to complete the match process.

In accordance with the invention, the compressed ternary mask method has several details. In particular, for each branch in the tree, at each level in the tree, there is one and only one entry with a particular mask length that merged with that branch. This allows the compression of the mask in the tree, and therefore allows unambiguous identification of a merge mask bit weight with a single leaf entry. In addition, the tree stores the complete binary length of the data in the tree so that there are no least significant bits stripped off in the tree, such as is done in cache hierarchies. This allows CIDR ternary to mix with binary numbers freely in the tree, and enables 1 unambiguous leaf access. In accordance with the invention, there are several choices for encoding the mask in the tree, combined with sorting in the leaf to find the entry in the leaf. This depends on insertion time desired, insertion rate and whether 2 leaf accesses are OK and these encodings include:

1) use 1 bit set in the mask value in the tree to uniquely indicate that an entry of that mask length is present in the next lower branch, and sort the merges into the least physical locations in that bin. This lets the tree resolve the exact physical address of the best ternary match returned from the tree, but requires more insertion effort.

2) as in 1), except don't sort the merges and perform an extra leaf access to resolve merges. (This may be the best choice in non-routing uses as it is statistically robust on 1 leaf access.) and

3) store each mask bit weight as an index value into the leaf bin. For instance, if there are 64 entries in a bin, then each bit weight would have 6 bits, instead of 1. This relieves the insertion algorithm from sorting at the expense of larger tree mask storage. This is the tradeoff chosen for the reference design.

In accordance with the invention, the entries within a bin DO NOT need to be sorted, as they are compared in parallel. This allows the “smoothing algorithm” to only move 1 entry from bin to bin, resulting in the robust worst case insertion rate. Furthermore, when multiple branch MERGES match a KEY at a level, the HIGHEST BRANCH MERGE is guaranteed to be the best CIDR match and mask in leaf can be a 5 bit quantity or an uncompressed 32 bit, depending on layout tradeoffs. Finally, new Ternary entries written to memory must have 0 stored in the data portion “under” the mask, so that the binary data portion of entries can combine with compressed masks unambiguously.

While the foregoing has been with reference to a particular embodiment of the invention, it will be appreciated by those skilled in the art that changes in this embodiment may be made without departing from the principles and spirit of the invention, the scope of which is defined by the appended claims.

1. A searching method, comprising:
providing a search tree having a root node, one or more branch nodes wherein each branch node has one or more leaf nodes containing data values to be matched and a mask value of the data, each branch node of the tree further comprising a value indicating the leaf values in the branch node and a compressed ternary mask for each branch node of the tree, the compressed ternary mask further comprising extracting the most significant bit of each mask contained in the branch node and logically ORing the most significant bits of the each mask together to generate the compressed ternary mask which represents the masks for all of the leaf nodes on the branch node of the tree;
selecting a branch node by comparing a key value to the value associated with each branch node;
comparing the key value to the values of the leaf nodes of the selected branch node to identify a matching value; and
if the leaf node value of the selected branch node does not match the key value, comparing the key value to the compressed ternary masks for the other branch nodes of the tree to identify a best match for the key value.
